(19) United States
(12) Patent Application Publication
(10) Pub. No.: US 2019/0193576 A1
(43) Pub. Date: Jun. 27, 2019

(54) CONTROL DEVICE OF VEHICLE AND CONTROL METHOD OF VEHICLE

(71) Applicant: SUBARU CORPORATION, Tokyo (JP)

(72) Inventors: Hironori KUROE, Tokyo (JP); Tomohiro MORITA, Tokyo (JP); Kazunari TAKEDA, Tokyo (JP)

(73) Assignee: SUBARU CORPORATION, Tokyo (JP)

(21) Appl. No.: 16/209,068

(22) Filed: Dec. 4, 2018

(30) Foreign Application Priority Data
Dec. 22, 2017 (JP) 2017-246086

(51) Int. Cl. B60L 15/20

(52) U.S. Cl. CPC B60L 15/20; B60L 2240/425; B60L 2240/423

(57) ABSTRACT

A control device of a vehicle includes a motor temperature acquirer; an oil temperature acquirer; and a torque controller. The motor temperature acquirer acquires a temperature of a motor that drives the vehicle. The oil temperature acquirer acquires a temperature of oil that cools the motor. The torque controller controls a torque of the motor on a basis of the temperature of the motor and the temperature of the oil.

### CROSS-REFERENCE TO RELATED APPLICATIONS

The present application claims priority from Japanese Patent Application No. 2017-246086 filed on Dec. 22, 2017, the entire contents of which are hereby incorporated by reference.

### BACKGROUND

### 1. Technical Field

The present invention relates to a control device of a vehicle and a control method of a vehicle.

### 2. Related Art

Conventionally, Japanese Unexamined Patent Application Publication (JP-A) No. 2005-86919 describes a device including a motor that is capable of outputting power to a drive axle and capable of exchanging electric power with a DC power source via an inverter.

### SUMMARY OF THE INVENTION

An aspect of the present invention provides a control device of a vehicle, the control device including: a motor temperature acquirer configured to acquire a temperature of a motor that drives the vehicle; an oil temperature acquirer configured to acquire a temperature of an oil that cools the motor; and a torque controller configured to control a torque of the motor on a basis of the temperature of the motor and the temperature of the oil.

An aspect of the present invention provides a control method of a vehicle, the control method including: acquiring a temperature of a motor that drives the vehicle; acquiring a temperature of an oil that cools the motor; and controlling a torque of the motor on a basis of the temperature of the motor and the temperature of the oil.

An aspect of the present invention provides a control device of a vehicle, the control device including circuitry. The circuitry is configured to acquire a temperature of a motor that drives the vehicle, acquire a temperature of an oil that cools the motor, and control a torque of the motor on a basis of the temperature of the motor and the temperature of the oil

### BRIEF DESCRIPTION OF THE DRAWINGS

FIG. 1 is a schematic diagram illustrating a configuration of a system according to an example of the present invention;

FIG. 2 is a flowchart illustrating a process performed by the system according to the example;

FIG. 3 is a schematic diagram illustrating a map for limiting torque of a motor generator;

FIG. 4 is a schematic diagram illustrating a map for limiting torque of the motor generator;

FIG. 5 is a schematic diagram illustrating a map for limiting torque of the motor generator;

FIG. 6 is a schematic diagram illustrating a map for limiting torque of the motor generator; and

FIG. 7 is a schematic diagram illustrating a relation between rotation speed (horizontal axis) and torque (vertical axis) of the motor generator.

### DETAILED DESCRIPTION

Hereinafter, preferred examples of the present invention will be described in detail with reference to the appended drawings. Note that the following description is directed to illustrative instances of the disclosure and not to be construed as limiting to the present invention. Factors including, without limitation, numerical values, dimensions, shapes, materials, components, positions of the components, and how the components are coupled to each other are for purposes of illustration to give an easier understanding of the present invention, and are not to be construed as limiting to the present invention, unless otherwise specified. Further, elements in the following instances which are not recited in a most-generic independent claim of the disclosure are optional and may be provided on an as-needed basis. The drawings are schematic and are not intended to be drawn to scale. Throughout this specification and the appended drawings, structural elements that have substantially the same function and structure are denoted with the same reference numerals, and repeated description of these structural elements is omitted.

When using the device described in JP-A No. 2005-86919 described above, the motor generates heat due to driving of the motor. Therefore, it is necessary to suppress overheating of the motor by cooling the motor in accordance with temperature of the motor or by lowering output (torque) from the motor. However, a rotor of the motor is a rotating body. Accordingly, it is impossible to directly measure temperature of a magnet of the rotor, and there is a problem that the magnet loses its function under a situation in which the temperature of the magnet of the rotor exceeds heatproof temperature.

On the other hand, for instance, in the case of trying to measure temperature of a static side (stator) of the motor and suppress overheating of the motor, it is assumed that output from the motor is excessively lowered in order to prevent the magnet of the rotor from losing its function. In this case, although the magnet of the rotor does not lose its function, there is a problem that the output from the motor is limited excessively.

Accordingly, it is desirable to provide a novel and improved control device and control method of a vehicle that are capable of suppressing overheating of a motor by optimally controlling torque of the motor.

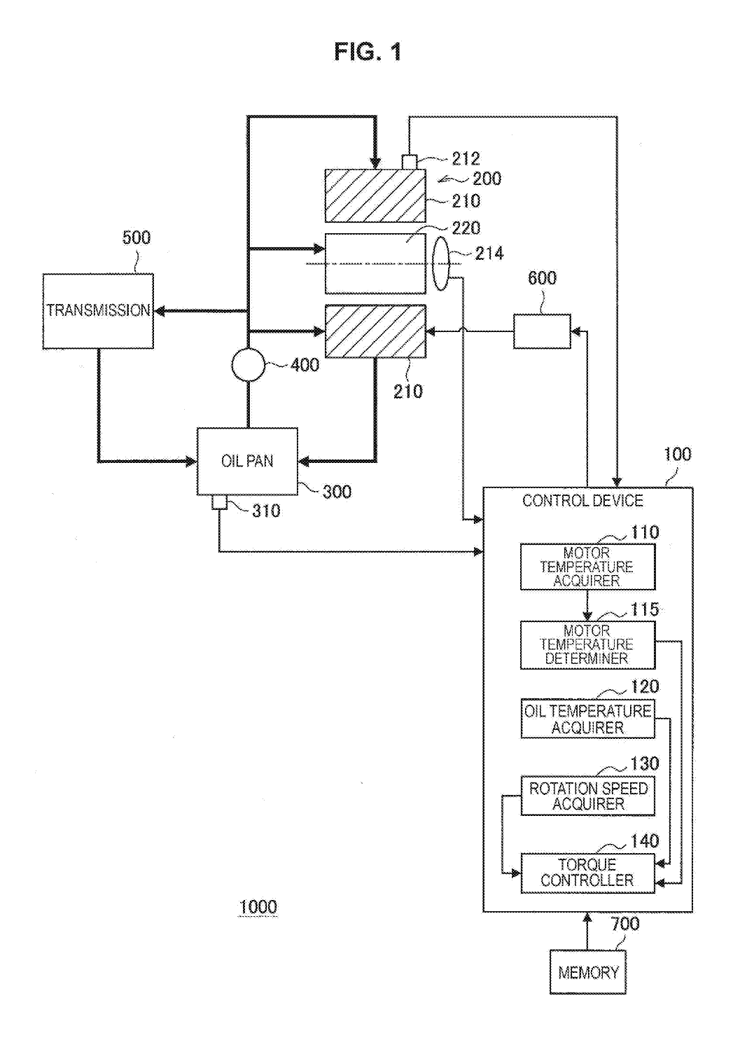

FIG. 1 is a schematic diagram illustrating a configuration of a system 1000 according to an example of the present invention. The system 1000 illustrated in FIG. 1 is mainly installed in a vehicle. As illustrated in FIG. 1, the system 1000 includes a control device (ECU) 100, a motor generator 200, an oil pan 300, an oil pump 400, a transmission 500, an inverter 600, and a memory 700. In one example, the motor generator 200 may serve as a “motor”, and the oil pan 300 may serve as a “reservoir”.

The control device 100 is a structural element that controls the whole system 1000. The motor generator 200 generates driving power for driving the vehicle. The driving power generated by the motor generator 200 is transmitted to wheels via the transmission 500. In addition, the motor generator 200 generates regenerative energy by using driving power conveyed from a road surface via the wheels.

The oil pan stores oil. The oil stored in the oil pan 300 is supplied to the motor generator 200 and the transmission 500 by driving the oil pump 400. The temperature of the oil stored in the oil pan 300 is detected by a temperature sensor 310.

The inverter 600 adjusts an electric current flowing to the motor generator 200 on the basis of a command value from the control device 100. The memory 700 stores maps (to be described later) for controlling torque of the motor generator 200.

The motor generator 200 includes a stator 210 and a rotor 220. The stator 210 includes a coil, and the rotor 220 includes a magnet. The stator 210 is provided with a temperature sensor (thermistor) 212 that detects temperature of the stator 210.

In addition, the motor generator 200 is provided with a rotation speed sensor 214 that detects rotation speed of the rotor 220. The rotation speed of the rotor 220 detected by the rotation speed sensor 214 is sent to the control device 100.

The motor generator 200 generates heat with generation of driving power. When a large electric current flows to the motor generator 200 in a state in which the motor generator 200 generates heat of a certain temperature or more, the temperature of the magnet of the rotor 220 exceeds heatproof temperature and sometimes this may produce defects in the magnet. In other words, there is a possibility that the magnet loses its function when high torque is generated by the motor generator 200 in a state in which the motor generator 200 is overheated.

On the other hand, although it is possible for the temperature sensor 212 to measure the temperature of the stator 210 of the motor generator 200, it is impossible to directly measure the temperature of the rotor 220 since the rotor 220 is a rotating body.

In addition, in the case where the temperature of the magnet of the rotor 220 increases in accordance with the oil temperature of the oil such as a case where the oil to be supplied to the motor generator 200 has already been heated, sometimes the temperature of the magnet of the rotor 220 exceeds the heatproof temperature when a large electric current flows to the motor generator 200.

As described above, in order to protect the magnet of the rotor 220 of the motor generator 200, it is desirable to perform control in view of the temperature of the stator 210 and the temperature of the oil such that the large electric current does not flow to the motor generator 200.

Therefore, the control device 100 controls the torque of the motor generator 200 on the basis of the temperature of the stator 210 and the temperature of the oil with reference to a map decided in advance. As illustrated in FIG. 1, the control device 100 includes: a motor temperature acquirer 110 that acquires temperature of the stator 210 detected by the temperature sensor 212; a motor temperature determiner 115 that determines temperature on the basis of the temperature acquired by the motor temperature acquirer 110; an oil temperature acquirer 120 that acquires temperature of oil in the oil pan 300 detected by the temperature sensor 310; a rotation speed acquirer 130 that acquires rotation speed of the motor generator 200 detected by the rotation speed sensor 214; and a torque controller 140 that controls torque of the motor generator 200 on the basis of the temperature of the stator 210, the temperature of the oil, and the rotation speed. Note that, the structural elements of the control device 100 illustrated in FIG. 1 can be configured by hardware (circuit) or a central processing unit such as a CPU and software (program) for causing it to function.

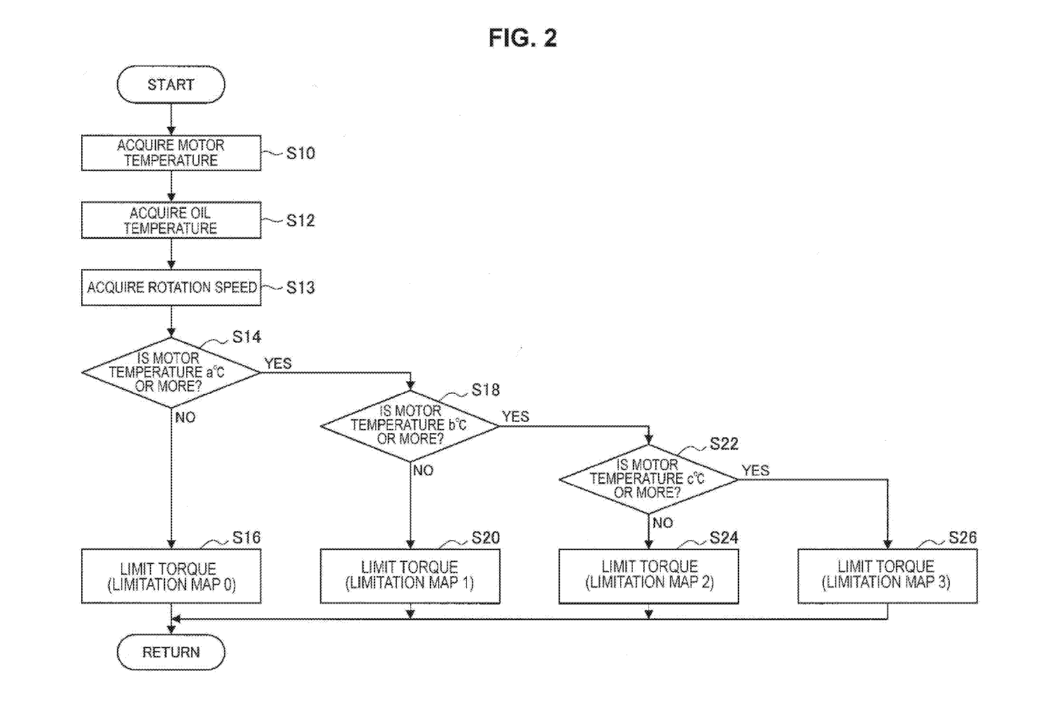

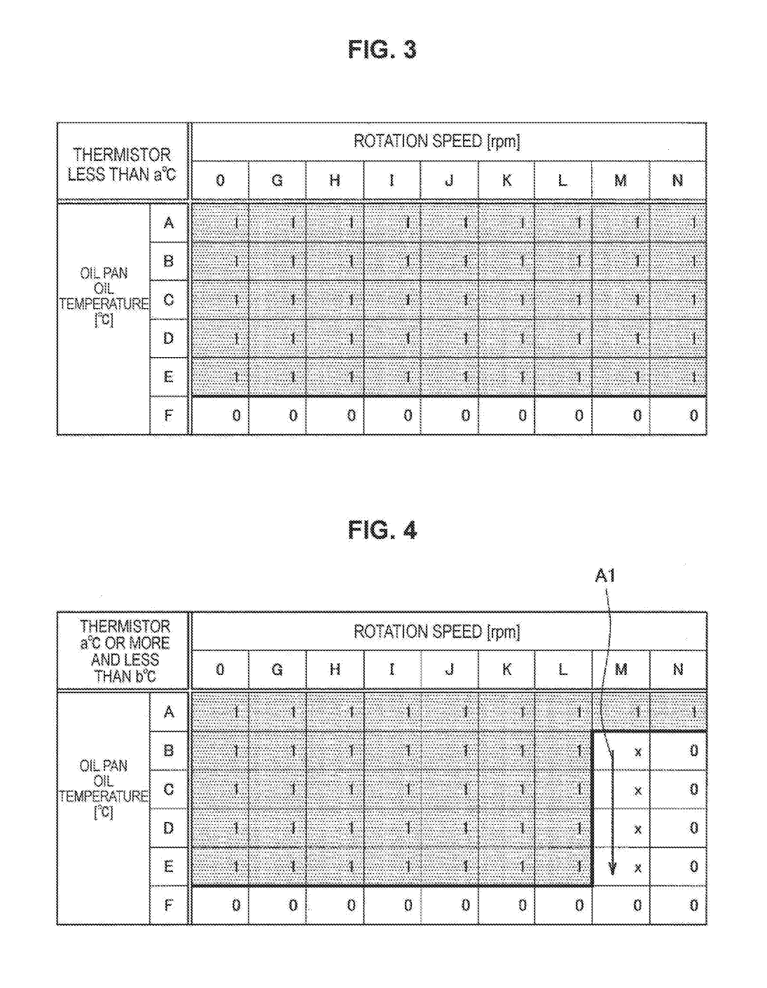

Next, a process performed by the system 1000 according to the present example will be described. FIG. 2 is a flowchart illustrating the process performed by the system 1000 according to the present example. In addition, FIG. 3 to FIG. 6 are schematic diagrams illustrating maps for limiting the torque of the motor generator 200. The maps illustrated in FIG. 3 to FIG. 6 define coefficients for limiting the torque of the motor generator 200 in accordance with rotation speed of the motor generator 200 and oil temperature in the oil pan 300. In the case where the coefficient is 1, the torque of the motor generator 200 is not limited. In the case where the coefficient is less than 1, the torque of the motor generator 200 is limited in accordance with the coefficient depending on the rotation speed of the motor generator 200 and the oil temperature in the oil pan 300. In FIG. 3 to FIG. 6, the oil temperature in the oil pan 300 has a relation in which A<B<C<D<E<F. In addition, the rotation speed of the motor generator 200 has a relation in which G<H<I<J<K<L<M<N. In addition, a coefficient x is a value less than 1, and the value of the coefficient x decreases in the direction of an arrow A1.

The process illustrated in FIG. 2 is mainly performed by the control device 100. First, in Step S10, the motor temperature acquirer 110 acquires the temperature of the stator 210. In the next Step S12, the oil temperature acquirer 120 acquires the temperature of the oil in the oil pan 300. In the next Step S13, the rotation speed acquirer 130 acquires the rotation speed of the motor generator 200.

In Step S14, the motor temperature determiner 115 determines whether the temperature detected by the temperature sensor 212 is a° C. or more. In the case where the temperature is not a° C. or more, the process proceeds to Step S16. In Step S16, the torque controller 140 limits the torque of the motor generator 200 on the basis of the limitation map “0” illustrated in FIG. 3. The torque controller 140 limits the torque of the motor generator 200 by multiplying target torque (allowed torque) set in accordance with a driving state by a coefficient defined with reference to the limitation map “0”.

In the case where the temperature detected by the temperature sensor 212 is a° C. or more in Step S14, the process proceeds to Step S18. In Step S18, the motor temperature determiner 115 determines whether the temperature detected by the temperature sensor 212 is b° C. or more. In the case where the temperature is not b° C. or more, the process proceeds to Step S20. Note that, a <b. In Step S20, the torque controller 140 limits the torque of the motor generator 200 on the basis of the limitation map “1” illustrated in FIG. 4.

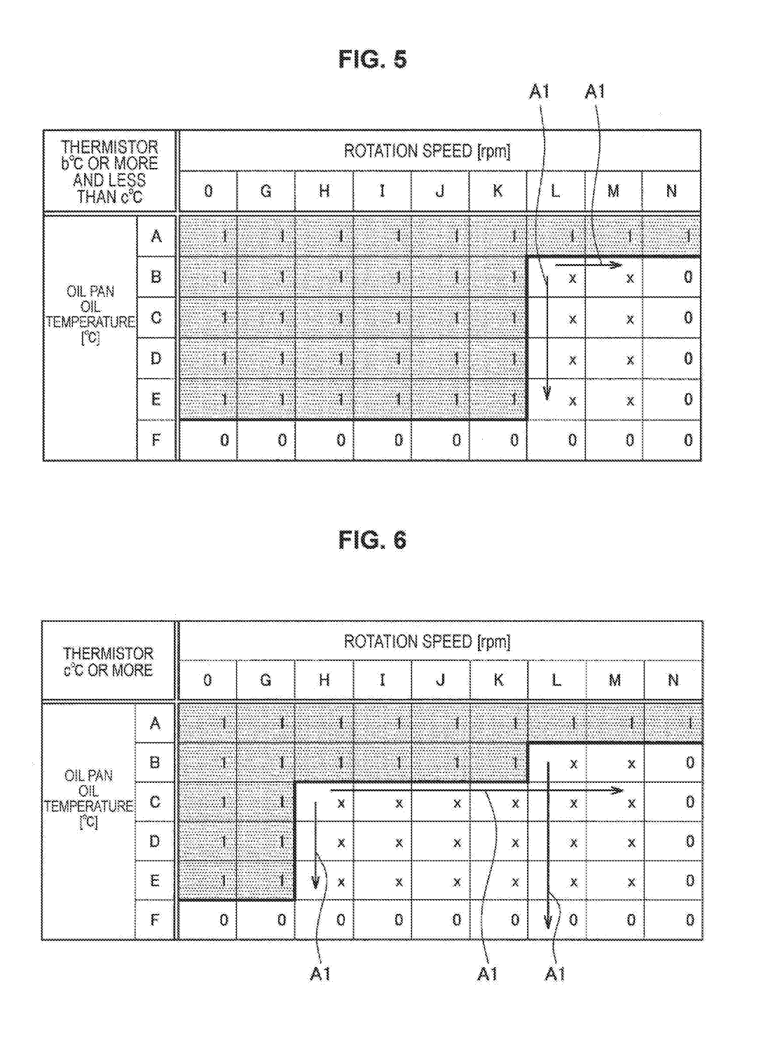

In the case where the temperature detected by the temperature sensor 212 is b° C. or more in Step S18, the process proceeds to Step S22. In Step S22, the motor temperature determiner 115 determines whether the temperature detected by the temperature sensor 212 is c° C. or more. In the case where the temperature is not c° C. or more, the process proceeds to Step S24. Note that, b<c. In Step S24, the torque controller 140 limits the torque of the motor generator 200 on the basis of the limitation map “2” illustrated in FIG. 5.

In the case where the temperature detected by the temperature sensor 212 is c° C. or more in Step S22, the process proceeds to Step S26. In Step S26, the torque controller 140 limits the torque of the motor generator 200 on the basis of the limitation map “3” illustrated in FIG. 6. After Step S16, S20, S24, or S26, the process ends (RETURN).

As described above, in the case where the temperature detected by the temperature sensor 212 is less than a° C., the limitation map “0” illustrated in FIG. 3 is used. In the limitation map “0” illustrated in FIG. 3, the torque is not limited in accordance with the rotation speed of the motor generator 200. However, in the case where the oil temperature in the oil pan 300 is F° C., the torque of the motor generator 200 is limited to “0”. In the case where the oil temperature in the oil pan 300 is F° C., it is assumed that the temperature of the rotor 220 is increased by heat of the oil and the magnet of the rotor 220 is damaged even when the temperature of the stator 210 detected by the temperature sensor 212 is less than a° C. Therefore, in the case where the oil temperature in the oil pan 300 is F° C., it is possible to suppress the damage in the magnet of the rotor 220 by limiting the torque of the motor generator 200 to “0”.

Note that, one of the causes of increase in the oil temperature in the oil pan 300 to F° C. regardless of the stator 210 with relatively low temperature, is overheating of another structural element cooled by the oil such as the transmission 500. Note that, although FIG. 1 illustrates the single motor generator 200, it is also assumed that the system 1000 includes the motor generators 200. In the system in which the motor generators 200 are cooled by the oil, the oil temperature of the oil in the oil pan 300 is increased by overheating of one of the motor generators 200, and the oil having the increased oil temperature is supplied to other of the motor generators 200.

In the case where the temperature detected by the temperature sensor 212 is a° C. or more and less than b° C., the limitation map “1” illustrated in FIG. 4 is used. In the limitation map “1” illustrated in FIG. 4, in a way similar to the limitation map “0” illustrated in FIG. 3, the torque of the motor generator 200 is limited to “0” in the case where the oil temperature in the oil pan 300 is F° C.

In addition, in the limitation map “1” illustrated in FIG. 4, the torque is limited in accordance with the rotation speed of the motor generator 200. Specifically, in the case where the rotation speed is M [rpm], the torque of the motor generator 200 is limited in accordance with a coefficient depending on the oil temperature in the oil pan 300. In this case, it is assumed that the temperature of the magnet of the rotor 220 increases as the oil temperature gets higher. Therefore, the torque is limited more as the oil temperature gets higher. In addition, in the case where the rotation speed is N [rpm], the torque of the motor generator 200 is limited to “0” except in the case where the oil temperature in the oil pan 300 is A° C.

In the case where the temperature detected by the temperature sensor 212 is b° C. or more and less than c° C., the limitation map “2” illustrated in FIG. 5 is used. In the limitation map “2” illustrated in FIG. 5, in a way similar to the limitation map “1” illustrated in FIG. 4, the torque of the motor generator 200 is also limited to “0” in the case where the oil temperature in the oil pan 300 is F° C.

In the limitation map “2” illustrated in FIG. 5, the torque is limited in accordance with the rotation speed of the motor generator 200. Specifically, in the case where the rotation speed is L [rpm] or M [rpm], the torque of the motor generator 200 is limited in accordance with a coefficient depending on the oil temperature in the oil pan 300. Here, it is assumed that the temperature of the magnet of the rotor 220 increases as the rotation speed gets higher. Therefore, the torque is limited more as the rotation speed gets higher. In addition, it is assumed that the temperature of the magnet of the rotor 220 increases as the oil temperature gets higher. Therefore, the torque is limited more as the oil temperature gets higher.

In addition, in the case where the rotation speed is N [rpm], the torque of the motor generator 200 is limited to “0” except in the case where the oil temperature in the oil pan 300 is A° C.

In the case where the temperature detected by the temperature sensor 212 is c° C. or more, the limitation map “3” illustrated in FIG. 6 is used. In the limitation map “3” illustrated in FIG. 6, in a way similar to the limitation map “1” illustrated in FIG. 4, the torque of the motor generator 200 is also limited to “0” in the case where the oil temperature in the oil pan 300 is F° C.

In the limitation map “3” illustrated in FIG. 6, the torque is limited in accordance with the rotation speed of the motor generator 200. Specifically, in the case where the rotation speed is H [rpm] to M [rpm], the torque of the motor generator 200 is limited in accordance with a coefficient depending on the oil temperature in the oil pan 300. Here, it is assumed that the temperature of the magnet of the rotor 220 increases as the rotation speed gets higher. Therefore, the torque is limited more as the rotation speed gets higher. In addition, it is assumed that the temperature of the magnet of the rotor 220 increases as the oil temperature gets higher. Therefore, the torque is limited more as the oil temperature gets higher. In addition, in the case where the rotation speed is N [rpm], the torque of the motor generator 200 is limited to “0” except in the case where the oil temperature in the oil pan 300 is A° C.

As described above, it is possible to suppress overheating of the magnet of the rotor 220 by limiting the torque of the motor generator 200 on the basis of the temperature of the motor generator 200, temperature of the oil, and the rotation speed of the motor generator 200. Accordingly, it is possible to protect the magnet before the temperature of the magnet of the rotor 220 exceeds the heatproof temperature and the magnet loses its function.

Note that, the maps illustrated in FIG. 3 to FIG. 6 are mere instances. It is possible to change values of the coefficient in accordance with specifications such as the heatproof temperature of the magnet.

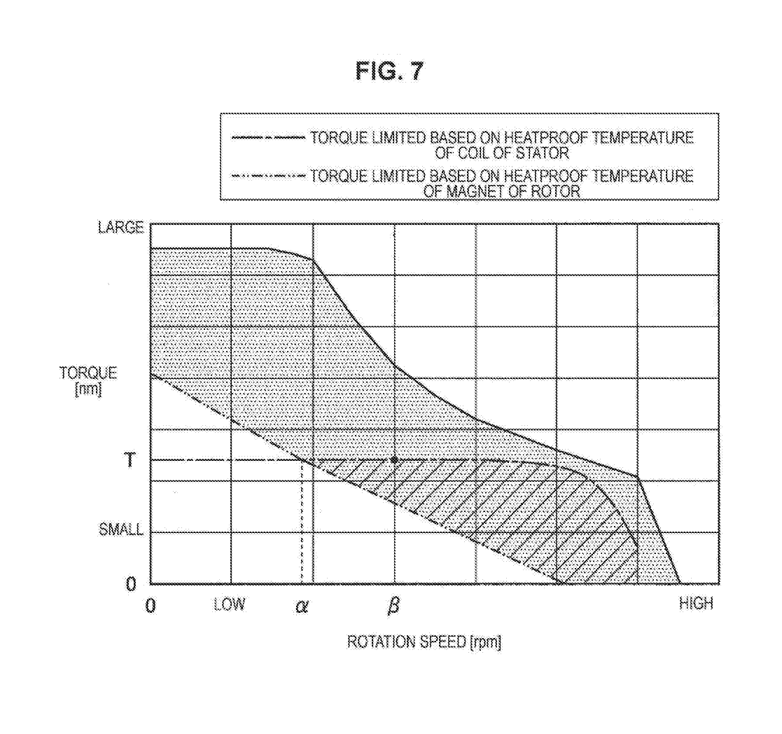

FIG. 7 is a schematic diagram illustrating a relation between rotation speed (horizontal axis) and torque (vertical axis) of the motor generator 200. In a way similar to characteristics of common motors, as indicated by the solid line in FIG. 7, the torque generated by the motor generator 200 decreases as the rotation speed gets higher. The characteristic indicated by the dashed-dotted line in FIG. 7 is a characteristic of an upper limit of the torque in the case where the torque of the motor generator 200 is limited on the basis of the heatproof temperature of the coil of the stator 210. The torque is limited such that the torque becomes smaller than the characteristic indicated by the dashed-dotted line in order to prevent the temperature of the stator 210 detected by the temperature sensor 212 from exceeding the heatproof temperature.

In addition, the characteristic indicated by the dashed-two-dotted line in FIG. 7 is a characteristic of an upper limit of the torque in the case where the torque of the motor generator 200 is limited on the basis of the heatproof temperature of the magnet of the rotor 220. The torque is limited such that the torque becomes smaller than the characteristic indicated by the dashed-two-dotted line in order to prevent the temperature of the magnet of the rotor 220 from exceeding the heatproof temperature.

In the case where the rotation speed of the motor generator 200 is relatively low, the upper limit of the torque based on the heatproof temperature of the magnet indicated by the dashed-two-dotted line is larger than the upper limit of the torque based on the heatproof temperature of the coil indicated by the dashed-dotted line. On the other hand, when the rotation speed of the motor generator 200 exceeds a [rpm], the upper limit of the torque based on the heatproof temperature of the coil indicated by the dashed-dotted line becomes larger than the upper limit of the torque based on the heatproof temperature of the magnet indicated by the dashed-two-dotted line.

If the torque is limited only on the basis of the upper limit of the torque based on the heatproof temperature of the coil indicated by the dashed-dotted line, the upper limit of the torque exceeds the upper limit of the torque based on the heatproof temperature of the magnet when the rotation speed of the motor generator 200 exceeds a [rpm]. For instance, when the motor generator 200 is driven by torque T [Nm] at rotation speed β [rpm], a value less than or equal to the upper limit of the torque based on the heatproof temperature of the coil is obtained. Therefore, it is possible to prevent the coil from getting thermal damage. However, in this case, the value exceeds the upper limit of the torque based on the heatproof temperature of the magnet. Therefore, there is a possibility that the magnet gets thermal damage. As described above, in the case where the torque is limited only on the basis of the upper limit of the torque based on the heatproof temperature of the coil indicated by the dashed-dotted line, it is impossible to protect the magnet in a hatched area (area incapable of protecting the magnet) illustrated in FIG. 7.

According to the present example, it is possible to suppress overheating and function loss of the magnet of the rotor 220 by limiting the torque of the motor generator 200 on the basis of the maps illustrated in FIG. 3 to FIG. 6, especially in the case where the temperature of the stator 210 is not identical to the temperature of the rotor 220.

As described above, according to the present example, the maps illustrated in FIG. 3 to FIG. 6 are switched on the basis of the temperature of the stator 210 detected by the temperature sensor 212, and the torque of the motor generator 200 is limited on the basis of the rotation speed of the motor generator 200 and the oil temperature of the oil. Therefore, it is possible to suppress loss of the magnet caused by overheating of the rotor 220 without driving the motor generator 200 in the area incapable of protecting the magnet illustrated in FIG. 7.

Although the preferred examples of the present invention have been described in detail with reference to the appended drawings, the present invention is not limited thereto. It is obvious to those skilled in the art that various modifications or variations are possible insofar as they are within the technical scope of the appended claims or the equivalents thereof. It should be understood that such modifications or variations are also within the technical scope of the present invention.

According to the example of the present invention, it is possible to suppress overheating of a motor by optimally controlling torque of the motor.

1. A control device of a vehicle, the control device comprising:
a motor temperature acquirer configured to acquire a temperature of a motor that drives the vehicle;
an oil temperature acquirer configured to acquire a temperature of an oil that cools the motor; and
a torque controller configured to control a torque of the motor on a basis of the temperature of the motor and the temperature of the oil.

2. The control device of a vehicle according to claim 1, the control device further comprising
a rotation speed acquirer configured to acquire a rotation speed of the motor,
wherein the torque controller controls the torque of the motor on a basis of the temperature of the motor, the temperature of the oil, and the rotation speed of the motor.

3. The control device of a vehicle according to claim 1,
wherein the motor temperature acquirer acquires the temperature of the motor from a temperature sensor configured to detect a temperature of a stator of the motor.

4. The control device of a vehicle according to claim 2,
wherein the motor temperature acquirer acquires the temperature of the motor from a temperature sensor configured to detect a temperature of a stator of the motor.

5. The control device of a vehicle according to claim 1,
wherein the oil temperature acquirer acquires the temperature of the oil from a temperature sensor configured to detect the temperature of the oil in a reservoir that stores the oil.

6. The control device of a vehicle according to claim 2,
wherein the oil temperature acquirer acquires the temperature of the oil from a temperature sensor configured to detect the temperature of the oil in a reservoir that stores the oil.

7. The control device of a vehicle according to claim 3,
wherein the oil temperature acquirer acquires the temperature of the oil from a temperature sensor configured to detect the temperature of the oil in a reservoir that stores the oil.

8. The control device of a vehicle according to claim 4,
wherein the oil temperature acquirer acquires the temperature of the oil from a temperature sensor configured to detect the temperature of the oil in a reservoir that stores the oil.

9. The control device of a vehicle according to claim 2,
wherein the torque controller limits the torque of the motor on a basis of a coefficient decided in accordance with the temperature of the motor, the temperature of the oil, and the rotation speed of the motor.

10. The control device of a vehicle according to claim 9,
wherein the torque controller increases a limitation amount of the torque of the motor as the rotation speed of the motor increases.

11. The control device of a vehicle according to claim 9,
wherein the torque of the motor is controlled on a basis of maps that define relations among the rotation speed of the motor, the temperature of the oil, and the coefficient that are set in advance in accordance with the temperature of the motor.

12. The control device of a vehicle according to claim 11,
wherein the torque controller expands a limitation range of the torque of the motor as the temperature of the oil increases in the map.

13. The control device of a vehicle according to claim 9,
wherein, when the temperature of the oil reaches a predetermined value, the torque controller limits the torque of the motor to zero regardless of the temperature of the motor and the rotation speed of the motor.

14. The control device of a vehicle according to claim 9,
wherein, in a case where the temperature of the motor is a predetermined value or less, the torque controller does not limit the torque of the motor regardless of the rotation speed of the motor, and in a case where the temperature of the oil reaches a predetermined value, the torque controller limits the torque of the motor to zero.

15. A control method of a vehicle, the control method comprising:
acquiring a temperature of a motor that drives the vehicle;
acquiring a temperature of an oil that cools the motor; and
controlling a torque of the motor on a basis of the temperature of the motor and the temperature of the oil.

16. A control device of a vehicle, the control device comprising:
circuitry configured to
acquire a temperature of a motor that drives the vehicle,
acquire a temperature of an oil that cools the motor, and
control a torque of the motor on a basis of the temperature of the motor and the temperature of the oil.
